(19) United States
(12) Patent Application Publication
(10) Pub. No.: US 2009/0230707 A1
(43) Pub. Date: Sep. 17, 2009

(54) Panel Grabber

(76) Inventor: Mark Scherger, Calgary (CA)

Correspondence Address: DIEDERIKS & WHITELAW, PLC, 12471 DILLINGHAM SQUARE, #301, WOODBRIDGE, VA, 22192, US

(21) Appl. No.: 12/047,084

(22) Filed: Mar. 12, 2008

(51) Int. Cl. B66C 1/48

(52) U.S. Cl. 294/104; 294/102.1; 294/164

(57) ABSTRACT

A removable device which slides over the top edge of a sheet to be picked up and carried, and which clamps the sheet when the handle is lifted, forming a single secure handle temporarily attached to the sheet for carrying without marring the sheet, at a handle height suitable to enable most workers to lift the sheet using mainly leg muscles in an efficient, safe and ergonomically sound manner

### FIELD OF THE INVENTION

In certain trades, such as woodworking, carpentry, framing, and dry walling (by example), workers are required to handle sheet goods such as (but not limited to) plywood, drywall, wallboard, decorative paneling and flooring. These sheets are typically 4′×8′ (but can be larger or smaller) and between ⅜″ and 1.5″ in thickness (most usually between ⅜″ and 1.0″ in panel thickness). Workers are required, during construction or renovation, or the work process with which they are engaged, to move such panels from place to place manually.

The present invention relates generally to manual manipulation (moving and carrying) of sheet goods. More particularly, the present invention relates to a handle which can temporarily be affixed to a sheet or sheets, to permit a worker to safely and efficiently pick up and carry the sheetgoods.

### BACKGROUND OF THE INVENTION

Sheet goods typically do not have any handles, and so are difficult to pick up and carry. This results in worker fatigue and injury, as well as damaged sheet goods and excessive worker time being spent. A summary of relevant prior art is discussed below:

U.S. Pat. No. 7,156,436B2 (Nguyen) discloses a clamping device which is placed over the top edge of a sheet, and lifted by a belt from overhead; the lifting force actuates the clamping force between two clamp faces; Nguyen's innovation seems to be that the clamp's moving face is forced toward its stationery face by movement of the strap-hanger against a ramp on the backside of the moving face and on the actuator's frame.

U.S. Pat. No. 6,494,513 (Worthington) discloses a manual panel-grabber which deploys a handle and hinges in a way that the handle must be lifted above the top edge of the sheet, making it awkward to use and ergonomically unsafe and inefficient.

U.S. Pat. No. 6,220,638 (Carroll) discloses a clamping device for carrying sheet goods made up of a long horizontal handle and body at each end of which is a clamp; when the clamps are slid over the top of the sheet goods, their jaws are opened by movement of the moveable clamp face upwards along a slanted groove; when the handle is lifted, friction between the moveable clamp-face and the sheet goods biases the moveable face downward along the slanted groove in such a way that the movable clamp-face is forced toward the sheet, causing a gripping motion. This invention has multiple clamps which passively engage, and a horizontally long body, and would be awkward in use and to store between uses. Carroll's grip on his handle is below the sheet goods' upper edge, but depends upon complex and easily jammed multiple passive clamps and an awkward and space-consuming design.

U.S. Pat. No. 6,113,167 (Mattis) discloses a panel grabber with a handle deployed well below the top edge of a carried sheet, but with a clamp mechanism that has the handle pivoting against one side of the clamp's throat to push and pull a rod which in turn moves a moveable clamp face toward and away from a stationary clamp face. The clamp mechanism is complex and would be expensive to build and difficult to maintain, having multiple moving parts and guideways.

U.S. Pat. No. 5,226,688 (Russo) discloses a panel carrying device which relies upon cams at the end of an arm pivoted near the top of the sheet against a second arm, the first arm's other end resting on the operator's shoulder, and the second end being pushed against the operator's leg, which uses the force of gravity on the sheet against the operator's shoulder, working against the operator's leg, to hold the cams in contact with the sheet. There are two long horizontal handles, one deployed well above the top edge of the sheet. The clamping force, clamp mechanism, and handle configuration use the operator's shoulder and leg to provide necessary clamping forces, and would be awkward and possibly painful to use. In addition, the Russo device would be more complicated and costly to build, and is larger, requiring more space to store between uses.

U.S. Pat. No. 3,253,849 (Hansen) discloses a set of panel clamps hung from a cable, clamped to a sheet over its top edge, and using a hinged moveable clamp, without any handles, instead depending from a cable overhead of the sheet. Hanson does not approach the problem of assisting in manual manipulation of sheet goods.

It is, therefore, desirable to provide a handle which slides over a sheet or sheets to be picked up and carried, without the disadvantages of the prior art.

### SUMMARY OF THE INVENTION

It is an object of the present invention to obviate or mitigate at least one disadvantage of previous art.

This invention is a handle which slides over the sheet to be picked up and carried, and which clamps when the handle is lifted, forming a secure handle temporarily attached to the sheet for carrying without marring the sheet, and at a height suitable for most workers (less than 48″ from the floor/ground), enabling the worker to lift the sheet using his or her legs in an efficient, safe and ergonomically sound manner.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side perspective of exemplary devices, alone;

FIG. 2 is a side perspective of exemplary devices, with panel;

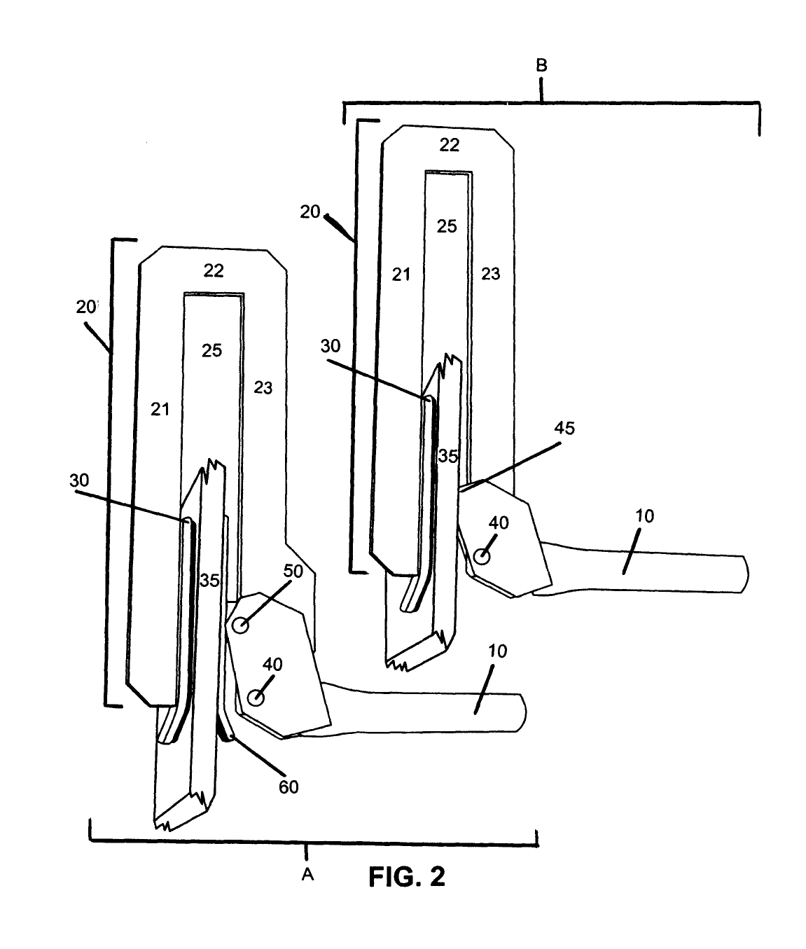

FIG. 3 is an exploded perspective of components of an exemplary device; and

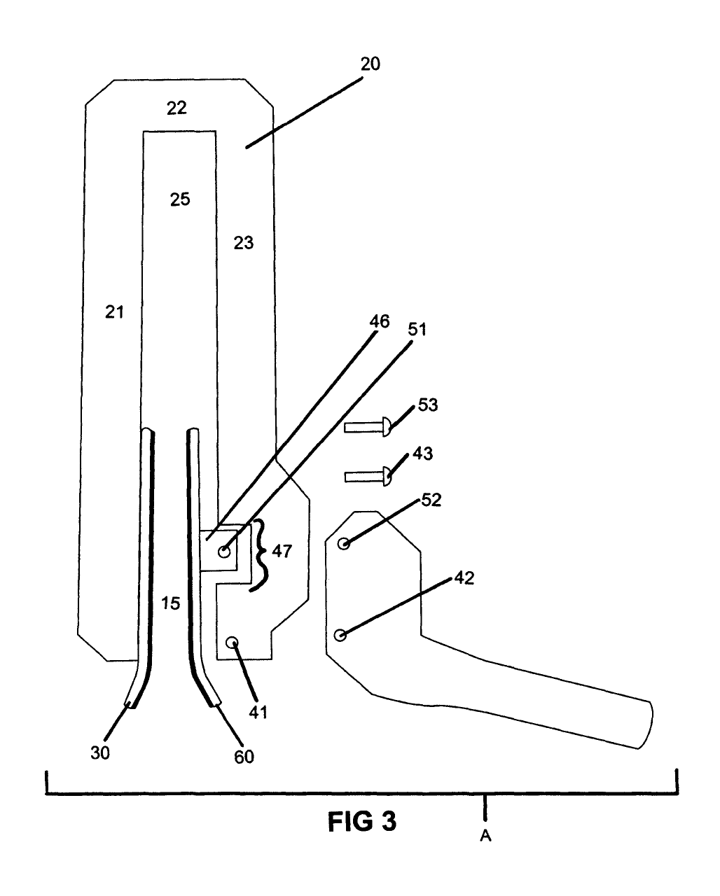

FIG. 4 is a sketch drawing of a human operator using the device, showing relevant size and distance measurements.

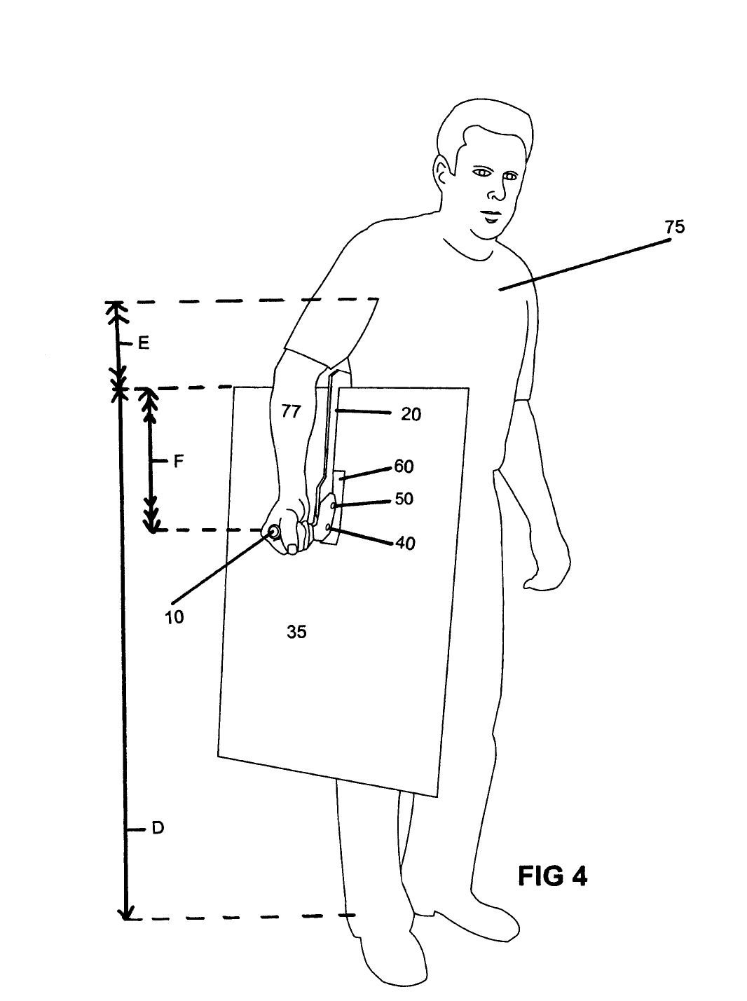

### DETAILED DESCRIPTION

Generally, the present invention provides a temporary handle for direct human manipulation of sheet goods, comprising:

1. a U-shaped body with:
i. a first arm to which is attached a first clamp-face;
ii. an end piece attached at one end to the first arm at the arm's end opposite the clamp-face; and
iii. a second arm attached at that arm's one end to the other end of the end piece, and to that arm's opposite end pivotally attached to a moving clamp element,
   2. a handle pivotally attached to the second arm's end and to the moving clamp element such that an upward movement of the handle moves the moving clamp element toward the first clamp-face;
   3. The throat between the two arms of the U-shaped body shaped to receive an upper edge of a vertical sheet to be clamped such that when used, the handle is deployed below the upper edge at a distance less than the distance from the human operator's armpit to the operator's hand on the handle, and where the throat's end, defined by the lower edge of the end piece, is below the human operator's armpit when the sheet is lifted, and above the sheet's upper edge both when the sheet is lifted and when the sheet is at rest.

In other embodiments, the apparatus has as the moving clamp element a second clamp-face facing the first clamp-face, pivotally attached to the handle or as a sharp portion of the part the other end of which is the handle to engage with a panel in the throat, opposite the first clamping-face. Similarly, either or both clamp-faces can be provided with a non-slip clamping surface. Preferably, the device, when placed over a 48 inch wide sheet (with its width being its height when manipulated for carrying to a vertical plane), has its handle's pivotal attachment to its second arm at a distance above the surface on which the human operator stands of between 24-32 inches, and with a throat between 2-4 inches wide and between 9-12 inches tall.

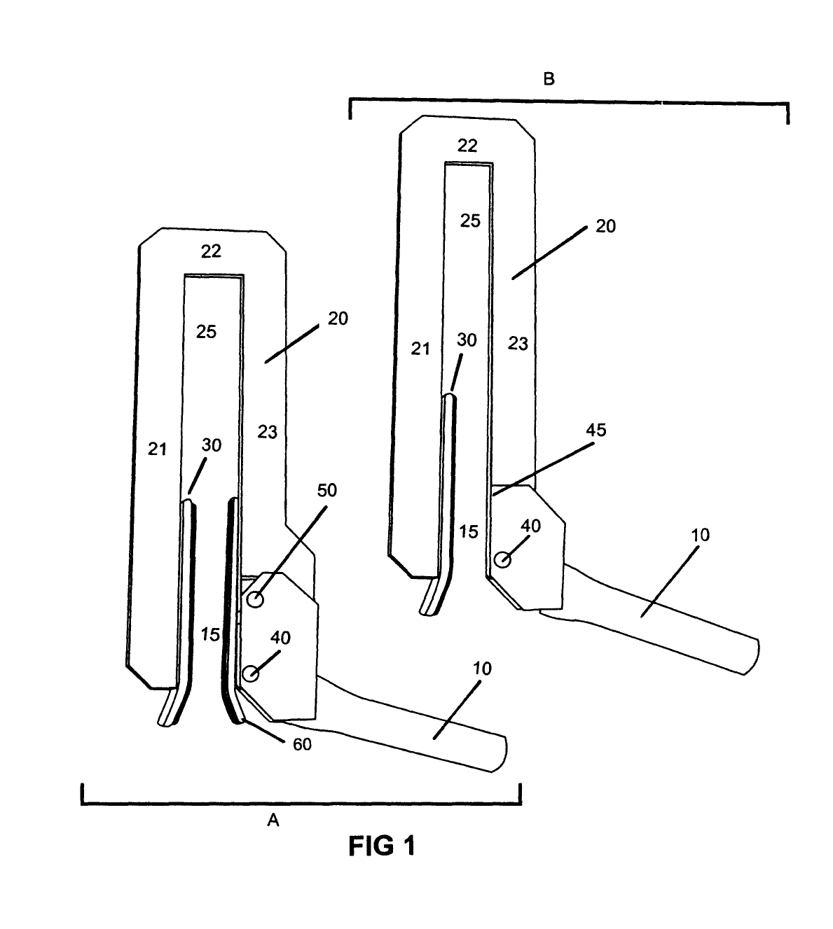

FIG. 1 shows the apparatus of this invention, its body 20 comprising one arm 21, a bridge or end piece 22, another arm 23, all welded or permanently affixed together to form a U-shaped throat 25 with an open end 15. Alternatively, the U-shaped body may be joined or made in a single piece. The body should be rigid, and may be made of any of a number of different suitable materials. Affixed to the first arm 21 is a clamp-face 30. To the second arm 23 is affixed a handle 10 at a pivot point 40. Attached to the handle 10 at a second hinge point 50 is a pivoting clamp-face 60. Pivoting clamp-face 60 has an attachment plate 46 with a hole 51 through which a pin or bolt or rivet 53 is placed to secure pivoting clamp-face 60 to second arm 23 through hole 52. Second arm 23 has a cutout 47 to accommodate attachment plate 46 when the handle 10 is positioned such that the space 15 between clamp-face 30 and pivoting clamp-face 60 is open (FIG. 1A). Pivoting clamp-face 60 and space 15 are preferably supplied with facing surfaces which are coated or manufactured to be non-slip.

In operation, the apparatus is slid so that space 25 is down over the top edge of a sheet 35, the handle 10 is lifted by a worker 75, causing the pivoting clamp-face 60 to pivot about hinge point 50 while handle 10 pivots about hinge point 40, pushing pivoting clamp-face 60 toward clamp-face 30, closing space 15 and frictionally engaging the sheet 35, thus providing a secure, temporary handle 10 with which the worker 75 may manipulate the sheet 35. The handle does not mar or harm the sheet's surface. The handle uses the weight of the sheet to provide force to the clamp-faces to more firmly hold heavier sheet goods.

Pivoting clamp-face 60 might be replaced by a pick or rubber foot or similar fixture to the end 45 of the handle 10 opposing clamp-face 30, particularly where the sheet 35 is “good-one-side” and the sheet's side engaging with the handle's pick or rubber foot at 45 is the “bad side”. Alternatively, the handle itself, without a pivoting clamp-face 60, could be used to engage the sheet directly.

The handle 10 is, in a preferred embodiment, when deployed on a sheet 35 by an operator 75 at a distance F below the operator's 75 armpit so that the operator's arm 77 is neither fully extended nor fully flexed, and so that distance E (the distance from the sheet 35 top edge and the operator's 75 armpit) is more than zero, while distance D is more than the height of the sheet 35, so that the operator 75 may lift the sheet 35 using mainly leg muscles and not back or arm 77 muscles, to prevent injury and fatigue.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A temporary handle for direct human manipulation of sheet goods, comprising
a. A U-shaped body with
i. A first arm to which is attached a first clamp-face
ii. An end piece attached at one end to the first arm at the arm's end opposite the clamp-face, and
iii. A second arm attached at that arm's one end to the other end of the end piece, and to that arm's opposite end pivotally attached to a moving clamp element
b. A handle pivotally attached to the second arm's end and to the moving clamp element such that an upward movement of the handle moves the moving clamp element toward the first clamp-face
c. The throat between the two arms of the U-shaped body shaped to receive an upper edge of a vertical sheet to be clamped such that when used, the handle is deployed below the upper edge at a distance less than the distance from the human operator's armpit to the operator's hand on the handle, and where the throat's end, defined by the lower edge of the end piece, is below the human operator's armpit when the sheet is lifted, and above the sheet's upper edge both when the sheet is lifted and when the sheet is at rest.

2. The apparatus of claim 1 where the moving clamp element comprises a second clamp-face facing the first clamp-face, pivotally attached to the handle.

3. The apparatus of claim 1 where the moving clamp element is a sharp portion of the part the other end of which is the handle to engage with a panel in the throat, opposite the first clamping-face.

4. The apparatus of claim 1 where the clamp-face is non-slip.

5. The apparatus of claim 2 where both clamp-faces are non-slip.

6. The apparatus of claim 1, when placed over a 48 inch vertical sheet, has its handle's pivotal attachment to its second arm at a distance above the surface on which the human operator stands of between 25-40 inches, and with a throat between 1-4 inches wide and between 9-15 inches tall.
